(19) United States
(12) Patent Application Publication
(10) Pub. No.: US 2006/0132856 A1
(43) Pub. Date: Jun. 22, 2006

(54) Image forming method and image forming apparatus

(75) Inventors: Jun Enomoto, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/287,351

(22) Filed: Nov. 28, 2005

(30) Foreign Application Priority Data
Nov. 26, 2004 (JP) 2004-341477
Nov. 29, 2004 (JP) 2004-343810

(51) Int. Cl. H04N 1/40

(52) U.S. Cl. 358/448

(57) ABSTRACT

The present invention provides an image forming method for outputting photographic prints. The image forming method includes the steps of: generating product images by performing a first image processing and a second image processing on all of images in one lot that are optically photographed; selecting at least one target image from among the images in the one lot; and outputting the product images and an unprocessed image obtained by performing only the first image processing on the target image. When images have been outputted by carrying out high-grade image processing, it becomes possible to make a customer who has ordered the images notice and recognize that the images have been outputted by carrying out the high-grade image processing.

The entire contents of literatures cited in this specification are incorporated herein by reference.

### BACKGROUND OF THE INVENTION

The present invention relates to an image forming method and an image forming apparatus which are used in a technical field of image formation for outputting photographic prints or the like, and capable of notifying a customer who has ordered photographic prints or the like that high-grade image processing has been carried out to output images in the case where the images have been outputted by performing high-grade image processing such as red eye correction processing.

In recent years, digital photoprinters have been put into practical use which each photoelectrically read images recorded on a film, convert the read images into digital signals, generate image data for recording by carrying out various kinds of image processing, and output prints by exposing a photosensitive material with recording light modulated in accordance with the image data.

In such a digital photoprinter, images photographed on a film are photoelectrically read and are converted into digital image data, and processing of the images and exposure of a photosensitive material are performed using the digital image data. Therefore, it is possible to create prints not only from images photographed on a film but also from images (image data) photographed with a digital camera or the like.

Also, as described above, in the digital photoprinter, images are dealt with as digital image data, so it is possible to perform image processing (correction or adjustment of the images) through processing of the image data.

Therefore, it is possible to perform image processing, such as color/density correction, gradation correction, color saturation correction, sharpness processing, and dodging processing (addition of a dodging effect through adjustment of an image dynamic range in which a halftone is maintained) with an extremely high degree of flexibility as compared with a case of a conventional analog exposure printer (printer that exposes a photosensitive material (printing paper) with projection light from a film), which makes it possible to reproduce high-quality images with stability even in the case of so-called overexposure, underexposure, backlight scenes, high-contrast scenes, and the like.

In addition, with the digital photoprinter, it is possible to perform, through processing of image data, image processing, such as red eye correction (correction of red eye targets ascribable to photographing using an electronic flash), deteriorated marginal luminosity correction (correction of density unevenness due to the deteriorated marginal luminosity of a photographing lens), aberration correction (correction of distortion due to aberration of a photographing lens), scratch removal processing (correction of defective pixels due to scratches in a film or a photographing lens, dusts adhering thereto, or the like), which requires an operator to have a highly sophisticated skill, is extremely difficult, or is substantially impossible with an analog exposure printer.

It is possible to obtain images with high image quality sufficient for photographic image quality by performing the color/density correction, the gradation correction, the color saturation correction, the sharpness processing, and the dodging processing. That is, it is possible to obtain finished prints at a level of products merely by performing these image processing.

In contrast to this, the red eye correction, the deteriorated marginal luminosity correction, the aberration correction, the scratch removal processing, and the like are processing that corrects image defects unrelated to the photographic image quality.

Here, in the case of the image processing such as the color/density correction or the gradation correction, it is possible to set image processing conditions and the like through analysis of low-resolution image data, such as so-called prescan data or thinned-out images, and an amount of computation and the like are not so large, so processing in a relatively short time is possible. In contrast to this, in the case of the red eye correction and the scratch removal processing, analysis using high-resolution image data corresponding to output is required and a large amount of complicated computation needs to be performed. Also, in the case of the aberration correction and the deteriorated marginal luminosity correction, information corresponding to a photographing lens is required and a large amount of complicated computation needs to be performed.

That is, the red eye correction, the deteriorated marginal luminosity correction, and the like can be referred to as high-grade image processing as compared with ordinary image processing, in which colors, densities, gradations, and the like are corrected to obtain appropriate finished images, and it is possible to make full use of advantages of digital exposure and output high-grade prints, in which image defects have been corrected, by executing the processing. However, the execution of the processing elongates a processing time and makes it necessary to use a sophisticated system.

However, a customer (person who requested creation of photographic prints) sees finishd prints, so even when high-grade image processing such as the red eye correction has been carried out, it is generally impossible for the customer to know the fact or the effect from finished prints.

Therefore, even when images having high quality as compared with a case of a general laboratory system or processing system have been finished by performing the high-grade processing by spending a long time and using a sophisticated image processing system, it is extremely difficult to make the customer notice and appreciate the fact.

As a method of solving those problems, in JP 2003-205660 A, a print method is described with which an image is selected from among images corresponding to a customer's order, and a print in which the image has been digitally enhanced (qualitatively improved/upgraded), and a print in which the image is not enhanced, are outputted.

With the method, it becomes possible to make the customer recognize that prints have been outputted by reproducing high-quality images through image processing and appreciate a result of the processing.

With the print method, however, it is impossible to sufficiently show the effect of the high-grade processing, such as the red eye correction, the scratch removal processing, the deteriorated marginal luminosity correction and the aberration correction, and it is also impossible to output unenhanced images with efficiency.

### SUMMARY OF THE INVENTION

The present invention has been made in order to solve the problems of the conventional techniques described above and has an object to provide an image forming method, with which when images have been outputted by performing high-grade image processing such as red eye correction on images photographed on a photographic film or images photographed with a digital camera or the like at much expense in time and effort, it becomes possible to make a customer or the like who has ordered the images notice and recognize that the images have been outputted by carrying out the high-grade image processing with reliability, and an image forming apparatus that implements the image forming method.

In order to attain the above-mentioned objects, a first aspect of the present invention provides an image forming method, including the steps of: generating product images by performing a first image processing and a second image processing on all of images in one lot that are optically photographed; selecting at least one target image from among the images in the one lot; and outputting the product images and an unprocessed image obtained by performing only the first image processing on the target image.

It is preferable that the step of outputting include outputting the unprocessed image and one of the product images corresponding to the unprocessed image consecutively in the one lot.

It is preferable that the first image processing be image processing for image completion and the second image processing be image processing for image defect correction.

It is preferable that the second image processing be performed on the images after the first image processing.

It is preferable that the image forming method of present invention further include the steps of: storing the unprocessed image in storage means; and reading the unprocessed image from the storage means in accordance with progress of the second image processing in the one lot to output the unprocessed image.

It is preferable that the image forming method of present invention further include the steps of; storing the target image in predetermined storage means; reading the target image from the storage means in accordance with progress of the first image processing and the second image processing in the one lot; and outputting the target image that is read after being subjected to the first image processing.

It is preferable that the second image processing include the steps of: analyzing information concerning each of the images to detect existence or nonexistence of an image defect; and performing an image defect correction only on an image detected to have an image defect in the step of analyzing information.

It is preferable that the information concerning each of the images contain at least one of an image and a photographing information.

It is preferable that the first image processing include an image enlargement/reduction, a gradation correction, a color/density correction, a color saturation correction, a sharpness processing and a dodging processing, and the second image processing comprises at least one of a red eye correction, an image defective part correction, a correction of aberration ascribable to a photographing lens and a correction of deteriorated marginal luminosity ascribable to the photographing lens.

It is preferable that the step of selecting include selecting the at least one target image in accordance with an inputted instruction, a result of analysis of an information concerning each of the images, or a selected one of the inputted instruction and the result of analysis of the information concerning each of the images.

It is preferable that the step of outputting the product images and the unprocessed image include the steps of; outputting the product images in order corresponding to numbers of the images in the one lot and outputting the unprocessed image immediately before or immediately after one of the product images that corresponds to the unprocessed image.

It is preferable that the step of outputting the product images and the unprocessed image include outputting the unprocessed image and one of the product images that corresponds to the unprocessed image at a start or an end of the one lot.

It is preferable that the step of outputting the product images and the unprocessed image include outputting product prints with the product images reproduced thereon and a reference print with the unprocessed image reproduced thereon by using the same kind of recording medium and the same image recording method.

It is preferable that the recording medium include printing paper.

It is preferable that the reference print differ from the product prints in print size.

It is preferable that the step of outputting the product images and the unprocessed image include reproducing an image obtained by performing the first image processing and the second image processing, and the unprocessed image obtained by performing only the first image processing on a hard copy.

It is preferable that the step of outputting the product images and the unprocessed image includes outputting a first image data containing the product images and a second image data that contains the unprocessed image and differs from the first image data in at least one of a data size and a header information.

In order to attain the above-mentioned objects, a second aspect of the present invention provides an image forming apparatus, comprising: image acquisinon means for acquiring all of images in one lot that are optically photographed; processing means for performing a first image processing that is image processing for image completion and a second image processing that is image processing for image defect correction on the images acquired; and selection means for selecting at least one target image from among the images in the one lot, wherein the processing means generates a product image by performing both of the first image processing and the second image processing and an unprocessed image by performing only the first image processing for the target image, and outputs both of the product image and the unprocessed image.

It is preferable that the image forming apparatus of present invention further include arrangement means for outputting the images in predetermined order, wherein the arrangement means sets image output order so that the unprocessed image and the product image corresponding to the unprocessed image are outputted consecutively in the one lot.

It is preferable that the image forming apparatus of present invention further include storage means for storing the images and the unprocessed image, wherein the unprocessed image is read from the storage means and is outputted in accordance with progress of the second image processing in the one lot.

It is preferable that the image forming apparatus of present invention further include storage means for storing the images and the target image, wherein the target image is read from the storage means in accordance with progress of the first image processing and the second image processing in the one lot, and is outputted after being subjected to the first image processing.

It is preferable that the first image processing includes an image enlargement/reduction, a gradation correction, a color/density correction, a color saturation correction, a sharpness processing and a dodging processing, and the second image processing comprises at least at least one of a red eye correction, an image defective part correction, a correction of aberration ascribable to a photographing lens and a correction of deteriorated marginal luminosity ascribable to the photographing lens.

It is preferable that the selection means include at least one of first selection means for selecting the target image in accordance with instruction inputted from outside and second selection means for selecting the target image through analysis of an information concerning each of the images, wherein one of a selection by the first selection means and a selection by the second selection means is selected as a mode in a case where the selection means includes both of the first selection means and the second selection means.

With the construction described above according to the present invention, when images have been outputted by carrying out high-grade image processing, such as red eye correction, correction of image (pixel) defective parts due to dusts adhering to a film or a lens, scratches in the film or the lens, or the like, correction of distortion of images due to aberration of a lens used to photograph the images, and correction of marginal density lowering due to deteriorated marginal luminosity of a lens used to photograph images, at much expense in time and effort, it becomes possible to make a customer requested print creation or image file creation recognize that the images have been outputted by carrying out the high-grade image processing.

Consequently, according to the present invention, it becomes possible to make a customer notice and recognize that high-grade processing or work, such as red eye correction, has been performed with reliability, and it becomes possible to achieve high-value-added images (products), differentiation from images not having undergone the high-grade processing, differentiation from other stores such as laboratory stores, price maintenance with respect to other stores, acquiring and ensuring of customers, and the like.

### BRIEF DESCRIPTION OF THE DRAWINGS

In the accompanying drawings:

FIGS. 1A and 1B are each a block diagram of an embodiment of the image forming apparatus according to the present invention;

FIG. 2 is a conceptual diagram for explanation of an example of a red eye correction method in the present invention;

FIGS. 3A and 3B are each a conceptual diagram for explanation of the example of the red eye correction method in the present invention;

FIGS. 4A and 4B are each a conceptual diagram showing an example of image output order in the present invention;

FIGS. 5A and 5B are each a conceptual diagram showing another example of the image output order in the present invention;

FIGS. 6A to 6F are each a conceptual diagram showing an example of an image template formed with the image forming method according to the present invention; and

FIG. 7 is a block diagram of another embodiment of the image forming apparatus according to the present invention.

### DETAILED DESCRIPTION OF THE PREFERRED EMBODIMENTS

Hereinafter, an image forming method and an image forming apparatus according to the present invention will be described in detail based on preferred embodiments illustrated in the accompanying drawings.

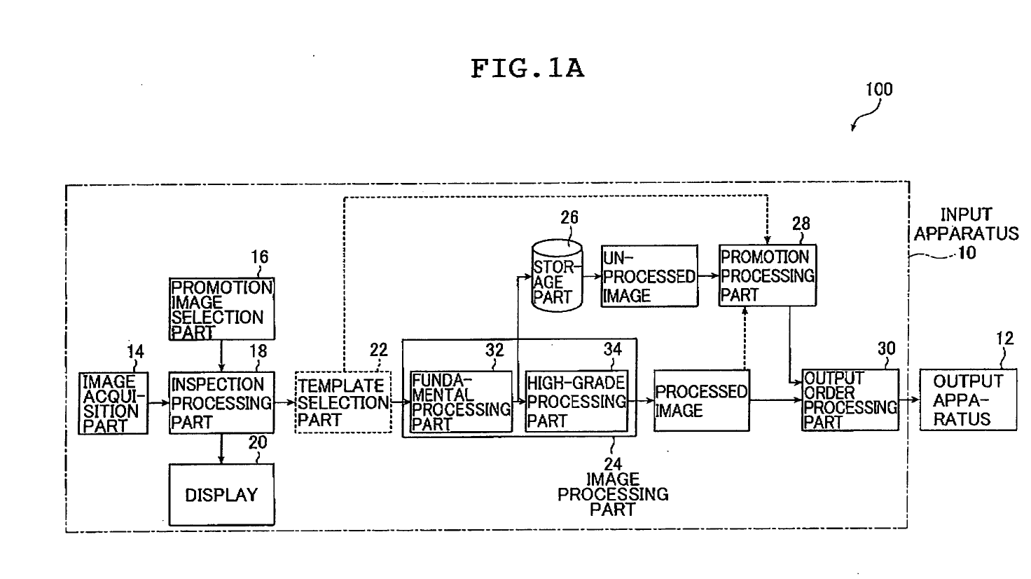

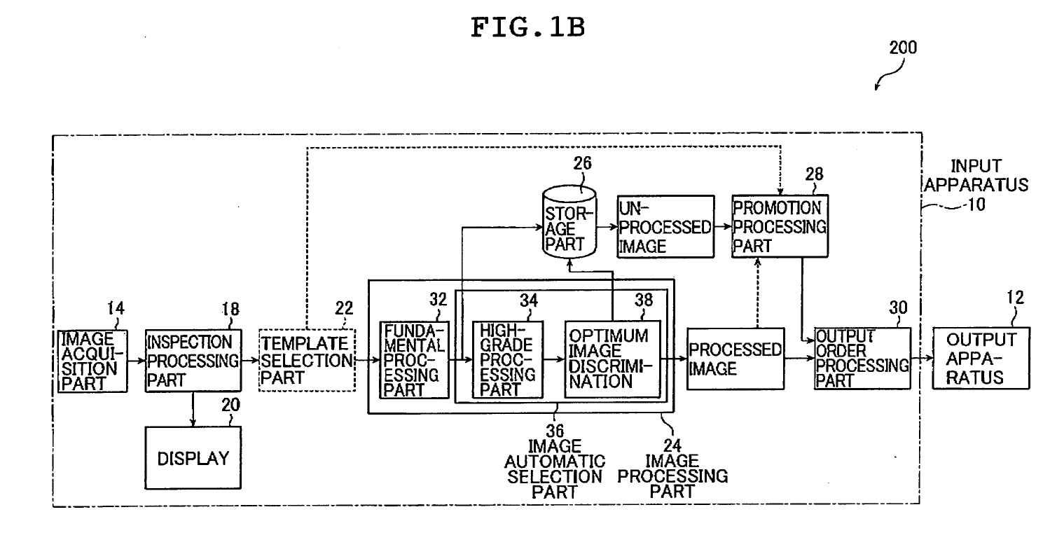

FIG. 1A is a block diagram of an embodiment of the image forming apparatus according to the present invention.

In FIG. 1A, arrows connecting blocks to each other indicate the flow of processing in the case where the image forming method according to the present invention is implemented in a digital photoprinter.

A digital photoprinter 100 includes an input apparatus 10 that acquires images (image data) and generates images (image data) for output, and an output apparatus 12 that outputs prints on which the images for output have been reproduced. The input apparatus 10 is an example of the image forming apparatus according to the present invention and includes an image acquisition part 14, a promotion image selection part 16, an inspection processing part 18, a display 20, a template selection processing part 22, an image processing part 24, a storage part 26, a promotion processing part 28, and an output order processing part (arrangement means) 30.

In the input apparatus 10, the image acquisition part 14 acquires images (image data) by photoelectrically reading images photographed on a photographic film using a scanner (not shown), and/or acquires images (image data) photographed with a photographing apparatus, such as a digital camera or a mobile telephone with a photographing function, from the photographing apparatus or a storage medium, such as a Smart Media™ or a PC Card™ in which the images photographed with the photographing apparatus are stored, through a communication network to which a personal computer, a print order reception terminal, and the like are connected, for instance.

The images (image data) acquired by the image acquisition part 14 are outputted by the input apparatus 10 to the inspection processing part 18. In order to have an operator conduct inspection, the inspection processing part 18 creates inspection images (finish simulation images) and displays the inspection images on the display 20. Also, the inspection processing part 18 is capable of setting conditions concerning image processing at the image processing part 24 and the like based on a result of the inspection by the operator. After the inspection, in the input apparatus 10, images (image data) for output are obtained by performing necessary image processing (fundamental processing and high-grade processing to be described later) at the image processing part 24 and are outputted to the output apparatus 12. Note that there is also a case where the inspection is not performed and the input apparatus 10 is not necessarily required to include the inspection processing part 18.

That is, it does not matter whether the input apparatus 10 has a function that supports only image formation from a photographic film, a function that supports only image formation through acquisition of images (that is, image data) photographed with a digital camera or the like, or a function that supports both image formation. Also, the digital photoprinter 100 may be constructed by connecting multiple input apparatus 10 and one or more output apparatus 12 to each other.

In the output apparatus 12 which received the images for output from the input apparatus 10, printing paper (photosensitive material) wound in a roll form or the like is drawn out and is cut in accordance with a print size, and latent images are formed on the printing paper by performing two-dimensional scan-exposure with recording light (laser light, for instance) modulated in accordance with the images supplied from the input apparatus 10 while conevying the printing paper. After the exposure, the printing paper is subjected to predetermined wet processing, is dried, is outputted as (finished) photographic prints, and is sorted in units of lots.

Alternatively, instead of or in addition to the output of the images for output to the output apparatus 12, the input apparatus 10 may record the images on a recording medium or output the images to an external apparatus through a communication network or the like collectively in units of lots.

In the input apparatus 10, image processing (fundamental processing and high-grade processing) to be described later is performed on every image in one lot at the image processing part 24, and the images after the processing are outputted. The promotion image selection part 16 is capable of performing processing in which one or multiple images (frames) that will become promotion images (reference images) for notifying a customer of the effect of the high-grade processing, are selected from among images in one lot as promotion target images. In the input apparatus 10, for the promotion target images selected at the promotion image selection part 16, in addition to images for output (product images) having undergone the fundamental processing and the high-grade processing, promotion images not having undergone the high-grade processing, that is, having undergone only the fundamental processing are generated and outputted. The promotion image selection part 16 is capable of giving the selected images information showing that the images have been selected as the promotion images. Also, the promotion image selection part 16 may store a result of the selection in the storage part 26 or the like.

The image processing part 24 includes a fundamental processing part 32 that carries out the fundamental processing on images and a high-grade processing part 34 that carries out the high-grade processing on the images having undergone the fundamental processing.

Here, the fundamental processing (first image processing) is fundamental image processing executed to output images having appropriate image colors/densities (tone reproduction, color reproduction), image structures (sharpness, graininess), and the like. By performing the fundamental processing, images are completed in terms of photographic image quality, that is, completed images are obtained, which correspond to image output such as ordinary print output in which no high-grade processing has been performed. In the illustrated embodiment, image enlargement or reduction (electronic scaling processing), gradation correction, color/density correction, color saturation correction, sharpness processing, and dodging processing (compression or expansion of image density dynamic ranges in which the halftones of images are maintained) are performed, for instance.

On the other hand, the high-grade processing (second image processing) is image processing that is carried out only on images having defects and corrects the image defects. More preferably, the high-grade processing is image processing in which corrections are made only on images detected as having defects as a result of analysis of information concerning images. More specifically, the high-grade processing is correction of red eyes ascribable to photographing using an electronic flash (red eye correction), correction of image (pixel) defective parts due to foreign matter adhering to a photographic film or a photographing lens and/or scratches in the photographic film or the photographing lens (scratch removal processing), correction of image distortion due to aberration of the photographing lens (lens aberration correction), and correction of marginal density lowering due to deteriorated marginal luminosity of the photographing lens (deteriorated marginal luminosity correction), for instance.

In the present invention, the information concerning images is the images themselves (image data itself) and photographing information of the images.

Here, concrete examples of the photographing information include information showing whether an electronic flash was used at the time of photographing, information showing a camera (lens) used to photograph the images, information showing a photographic film on which the images have been photographed, information showing an aperture at the time of the photographing, and information showing a shutter speed. In the case of image formation from an APS film, for instance, it is sufficient that the photographing information is acquired from magnetic information recorded in the film. Also, in the case of images photographed with a digital camera or the like, it is sufficient that the photographing information is acquired from information recorded in image files.

Hereinafter, the embodiment of the image formation according to the present invention shown in FIG. 1A will be described in more detail by assuming that the red eye correction is carried out as the high-grade processing at the high-grade processing part 34.

Also, in the following description, for ease of explanation, images having undergone both of the fundamental processing and the high-grade processing (case where only analysis of information concerning images has been carried out and no correction has been made is included) will be referred to as the “processed images” and images having undergone only the fundamental processing will be referred to as the “unprocessed images”. Further, prints, on which promotion images created based on the unprocessed images have been reproduced, will be referred to as the “promotion prints”.

The embodiment shown in FIG. 1A is an embodiment in which selection of promotion target images is made in accordance with instructions inputted by an operator at the promotion image selection part 16 of the input apparatus 10 (manual selection of promotion images is made).

In the embodiment shown in FIG. 1A, in the input apparatus 10, when images (image data) in one lot have been acquired at the image acquisition part 14 in the manner described above (or midway through the image acquisition), inspection images are created at the inspection processing part 18 and are displayed on the display 20, thereby having the operator conduct inspection. Note that the inspection images have undergone image processing corresponding to the fundamental processing. Also, image processing conditions concerning the fundamental processing at the fundamental processing part 32 of the image processing part 24 may be set through analysis of original images of the inspection images or the like. For instance, when color/density adjustment or the like is performed through the inspection, the image processing conditions concerning the fundamental processing at the fundamental processing part 32 are also changed accordingly.

In the illustrated embodiment, it is sufficient that the displaying of the inspection images is performed in the same manner as in the case of ordinary digital photoprinters. That is, when images have been acquired by reading a film using a scanner, it is sufficient that the inspection image displaying is performed with images (prescan data) obtained through prescan performed prior to fine scan that is image reading for output, and when images photographed with a digital camera or the like have been acquired, it is sufficient that the inspection image displaying is performed with images obtained by thinning out (or reducing) the acquired images.

It should be noted that in the digital photoprinter in the illustrated embodiment, the inspection is not an indispensable process. That is, images may be outputted without conducting the inspection. Also, an ordinary mode in which the inspection is conducted, and an automatic mode in which the inspection is not conducted, may be set as operation modes and images may be outputted by selecting one of the operation modes.

Also, in the case of reading of a film with a scanner, fine scan may be performed after the inspection has been ended or may be performed to successively follow prescan.

In the illustrated embodiment, an inspection screen displayed on the display 20 doubles as a screen for the promotion target image selection at the promotion image selection part 16, and the operator inputs designation of promotion target images through the promotion target image selection screen using known means such as a graphical user interface (GUI) (the same applies to other selection carried out in the following description). The promotion image selection part 16 acquires images designated and selected by the operator as promotion target images. It does not matter whether the promotion target image selection (designation input) is made for one frame or multiple frames. Note that the promotion image selection part 16 may display a selection criterion in automatic selection to be described later or information concerning the selection criterion on the display 20 to assist the promotion target image selection by the operator.

It should be noted that when no image has been selected as a promotion target image in one lot, output of a promotion print (creation of promotion image) is not performed in the order. Also, when the inspection is not conducted, images for the promotion target image selection (preferably, images that are the same as the inspection images) are displayed.

When the inspection has been ended, the fundamental processing is next carried out on respective images in frames in one lot in order. Note that the images are images corresponding to output. More specifically, in the case of print creation from a photographic film, the images are fine scan images (fine scan data) and in the case of images obtained with a digital camera or the like, the images are photographed images (photographed image data).

In the illustrated embodiment, as described above, as the fundamental processing, image enlargement or reduction (electronic scaling processing), gradation correction, color/density correction, color saturation correction, sharpness processing, and dodging processing are performed.

It is sufficient that each image processing is performed with a known method.

Here, processing by the template selection processing part 22 illustrated in FIG. 1A between the inspection processing part 18 and the fundamental processing part 32 will be described in detail later.

Images having undergone the fundamental processing are next subjected to the red eye correction (high-grade processing) in order. Here, images selected as promotion target images at the promotion selection part 16 and having undergone the fundamental processing at the fundamental processing part 32 are sent to the high-grade processing part 34 and are subjected to the red eye correction, and also sent to the storage part 26 and are stored therein. Consequently, in the storage part 26, images (unprocessed images) selected as promotion target images and having undergone only the fundamental processing are stored.

It should be noted that when at this time, photographing information has been acquired and it has been found as a result of analysis of the photographing information that images are photographed without using an electronic flash, the red eye correction is not performed on the images because the images cannot become targets of the red eye correction. In this case, however, the images are set as images having undergone the fundamental processing and the red eye correction (high-grade processing) without actually performing the red eye correction and are processed as processed images.

A method of carrying out the red eye correction is not specifically limited and various known methods are usable. A preferable example of the red eye correction method will be described below.

In the red eye correction, first, red eye candidates (regions that are likely to be red eyes) are detected from images having undergone the fundamental processing, and information showing the positions of the red eye candidates (center coordinate position information), information showing the regions of the red eye candidates, information showing the number of the red eye candidates, and the like are obtained.

Here, images, in which no red eye candidate has been detected through the red eye candidate detection, are set as non-red eye images containing no red eye. Then, at this time, the red eye correction is ended and the images are set as processed images having undergone the fundamental processing and the red eye correction without making image correction.

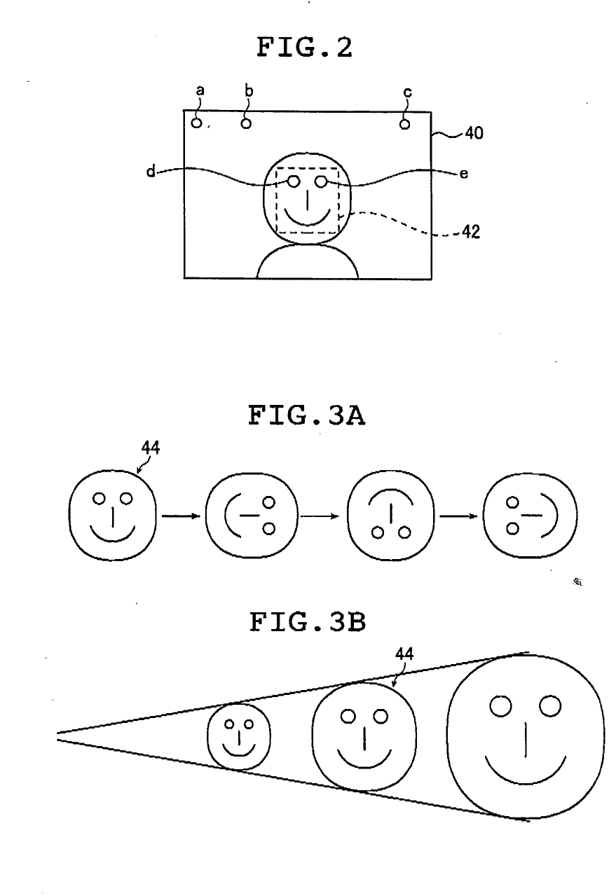

In the case of an image (scene) 40 shown in FIG. 2 in which a human subject has been photographed against a background containing three red lamps and a red eye phenomenon has occurred to the human subject, for instance, not only regions a, b, and c corresponding to the red lamps but also regions d and e corresponding to red eyes are detected as red eye candidates.

A method of detecting the red eye candidates is not specifically limited and various known methods are usable.

For instance, it is possible to use a method with which round regions that each have a red hue and a predetermined or more number of pixels are extracted using red eye color information (red eyes are red) and shape information (red eyes are round), and regions, whose red eye degrees (degrees by which the regions are likely to be red eyes) and round degrees (degrees by which the regions are round) which are set in advance from a large number of red eye image samples exceed threshold values, are detected as red eye candidates that are likely to be red eyes.

Next, face detection is performed in peripheral regions containing the detected red eye candidates using a result of the red eye candidate detection (position information described above, for instance).

In the example shown in FIG. 2, for instance, the face detection is performed in predetermined regions containing the red eye candidates a, b, c, d, and e in order. Accordingly, in the illustrated example, a region 42 surrounded, for example, by a dotted line is detected as a face region, and information showing that the red eye candidates d and e are red eye candidates contained in the face region is obtained or the information showing that the red eye candidates d and e are contained in the face region and information as to the face region are obtained.

A method of carrying out the face detection is not specifically limited and various known methods are usable.

As a preferred example, it is possible to use a method with which face detection is performed through template matching using an average face image or a template of face (hereinafter referred to as the “face template”) created in advance from a large number of face image samples.

With the method, the face detection is performed by, for instance, performing matching (confirmation of matching degree) between the face template which is a combination of a direction and a size of various faces and face candidate regions in an image in order by rotating the face template (or target image) 44 in a clockwise direction with respect to an image plane (by 0°, 90°, 180°, and then 270°) in accordance with a camera direction at the time of photographing (vertical direction (vertical photographing)/horizontal direction (horizontal photographing), for instance) as shown in FIG. 3A and performing changing of the face size (enlargement/reduction=resolution conversion) of the face template (or target image) 44 in accordance with the size (resolution) of the face in the image as shown in FIG. 3B.

It should be noted that instead of the face template rotation and enlargement/reduction, rotated face templates and enlarged/reduced face templates may be created in advance and the matching may be performed using the templates. Also, it is sufficient that the face candidate region detection is performed using means based on flesh color extraction or contour extraction, for instance.

It should be noted that the face detection method is not limited to the method based on the template matching.

For instance, a face detection using a learning technique is preferably exemplified. With the method, many face images and non-face images are prepared to extract each of the characteristic amounts. Based on the results, a suitably selected learning technique is used to perform preliminary learning in which a function or a threshold value for separating faces and non-faces from each other is calculated. When face detection is performed, face detection using a learning technique is preferable with which characteristic amounts are extracted from a target image in the same manner as in the preliminary learning and performing discrimination between faces and non-faces using the function or the threshold value obtained through the preliminary learning.

In addition, aside from the face candidate detection method based on the matching using the face template, it is also possible to use a face detection method based on shape recognition through edge (contour) extraction and edge direction extraction disclosed in JP 08-184925 A and JP 09-138471 A, a face detection method based on color extraction such as flesh color extraction or black extraction, a face detection method based on a combination of the shape recognition and the color extraction, and the like.

In the manner described above, the red eye candidates on whose peripheries faces have been detected using a result of the red eye candidate detection and information as to the red eye candidates for which faces have been detected are identified as red eyes.

Here, images, in each of which no face has been detected on the peripheries of red eye candidates through the face detection, are judged as non-red eye images. Then, at this time, the red eye correction is ended and the images are regarded as images having undergone the fundamental processing and the red eye correction without making image correction. After this, the images are processed as processed images.

After the red eyes have been identified in the manner described above, the red eye correction is performed on the identified red eye regions through image processing, thereby generating processed images having undergone the fundamental processing and the red eye correction.

A method of correcting the red eyes is not specifically limited and various known methods are usable. For instance, it is possible to use processing in which the red eyes are corrected by controlling the color saturation, brightness, hues, and the like of the red eye regions in accordance with image characteristic amounts of the red eyes and red eye peripheries (which may contain face peripheries) and the like, correction processing in which the colors of the red eye regions are merely converted into black, and the like.

By first performing the red eye candidate detection, next performing the face detection only on the peripheries of detected red eye candidates, and then identifying red eye candidates, on whose peripheries faces have been detected, as red eyes in the manner described above, it becomes possible to significantly shorten a time taken by the red eye detection.

That is, the red eye detection including the face detection has conventionally been time-consuming processing. More specifically, in conventional red eye detection, after the face detection has been performed, the red eye detection is performed in detected face regions, so the face detection is performed also in regions in which no red eye exists, and therefore an extremely long time is taken by the face detection. In contrast to this, in the present invention, red eye candidates are first detected and then the face detection is performed only in predetermined regions containing the red eye candidates in the manner described above, so it becomes possible to eliminate unnecessary face detection in regions in which no red eye exists, and significantly shorten a time taken by the face detection in the red eye detection.

It should be noted that the red eye correction method (red eye correction algorithm) is not limited to the method described above. That is, it is also possible to use an ordinary red eye correction method with which the face detection is first performed and then the red eye detection is performed. In addition, every known red eye correction method is usable.

Also, the present invention is not limited to the form in which every apparatus uses the same red eye correction method. That is, one or more or all apparatus may use mutually different red eye correction methods.

The processed images having undergone the red eye correction in the manner described above are supplied to the output order processing part 30 in order as images (product images) to be reproduced on product prints (finished photographic prints).

On the other hand, the promotion target images stored in the storage part are read at a predetermined timing and are supplied to the promotion processing part 28 that forms images for promotion prints.

The promotion prints may be prints obtained by forming the images for the promotion prints so that the unprocessed images of the promotion target images are reproduced as promotion images as they are and reproducing the promotion images (unprocessed images) in completely the same manner as the processed images for product prints. In this case, the promotion images are supplied to the output order processing part 30 without being processed at the promotion processing part 28.

However, it is preferable that the promotion processing part 28 create the images for the promotion prints in the manner described below. That is, the promotion processing part 28 provides margin parts on prints by forming the promotion images while reducing the unprocessed images or provides the margin parts on the prints by using the unprocessed images as the promotion images as they are and setting the print size of the promotion prints larger than that of the product prints, and records comments for making a customer recognize that, for instance, the red eye correction has been carried out in the margin parts outside the promotion images.

The contents of the comments are not specifically limited. For instance, it is possible to record, in the margin parts, a comment telling that the red eye correction has been performed on the images, information showing other frames (images) in which the red eye correction has been performed, information for notifying a customer of the effect of the red eye correction (high-grade processing), an advertisement by a store such as a laboratory store, an advertisement for a digital photoprinter or its manufacturer, advice about photographing, a discount coupon, an advertisement for a camera, sightseeing/excursion information, a comment in which those information items have been combined with each other, or the like.

Also, there are various preferable methods of setting the contents of the comments. For instance, it is preferable that multiple comments be set in advance and at least one of the comments is selected. Alternatively, it is preferable that the contents of the comments be settable arbitrarily. In addition, it is preferable that the recording position, font, character size, color, and the like of the comments are selectable/settable arbitrarily.

Here, in the present invention, it is preferable that the size of the promotion prints be set larger than that of the product prints or the size of the promotion prints be set smaller than that of the product prints, and it is preferable that the images for the promotion prints be formed in accordance with the size of the promotion prints. Also, when image data is outputted as a product, it is preferable that the image size of product images and that of images containing promotion images be set to be different from each other. Alternatively, instead of the image size, header information given to the product images and that given to the images containing the promotion images may be set to be different from each other. Still alternatively, the image size and the header information of the product images and those of the images containing the promotion images may be set to be different from each other.

By setting the size of the promotion prints different from that of the product prints, it becomes possible to notify a customer of the existence of the promotion prints more suitably. Note that a form in which the size of the promotion prints is set larger than that of the product prints is advantageous in terms of the effectiveness of notifying a customer of the existence of the promotion prints, and a form in which the size of the promotion prints is set conversely smaller than that of the product prints is advantageous in terms of suppression of an increase in cost through, for instance, reduction of the consumption amount of the printing paper (it is considered that the promotion prints are ordinarily outputted at no charge) and the like.

Also, the promotion processing part 28 may prepare various sizes of the promotion prints that are the same as that of the product prints, smaller than that of the product prints, and larger than that of the product prints, and may make a selection from among the sizes. Alternatively, the promotion processing part 28 may select the size of the promotion prints arbitrarily.

Further, in addition to the promotion prints, as necessary, the product prints corresponding to the promotion prints (that is, the product prints on which the processed images corresponding to the promotion images reproduced on the promotion prints have been reproduced) may be set as prints whose size is different from that of ordinary product prints.

It does not matter whether the size of the promotion prints or the size of the promotion prints and the product prints thereof is changed from that of ordinary product prints by changing only a long-side size, only a short-side size, or both of the long-side size and the short-side size.

Here, when consideration is given to output as prints, it is preferable that the print size be changed in the lengthwise direction of the rolled printing paper loaded into the output apparatus 12, and the images for the promotion prints or the images for the promotion prints and the images for their corresponding product prints be formed accordingly. For changing the print size in a direction different from the lengthwise direction, it becomes necessary to load printing paper with different widths (sizes). Even when it is possible to load various kinds of printing paper having different widths to the output apparatus 12, complicated control and operation need to be performed to supply the printing paper while performing width switching in one lot, which is unpreferable.

The images for the promotion prints formed through the promotion processing are supplied to the output order processing part 30. In addition, the processed images to be reproduced on the product prints are also supplied to the output order processing part 30 in order, as described above.

The output order processing part 30 arranges the images in a predetermined print output order and outputs the arranged images to the output apparatus 12.

In the present invention in which in addition to the product prints on which the processed images having undergone the fundamental processing and the red eye correction (high-grade processing) have been reproduced, the promotion prints, on which the promotion images formed from the unprocessed images in order to notify a customer of the effect of the high-grade processing have been reproduced, are outputted, the promotion prints and the product prints corresponding to the promotion prints are outputted consecutively.

Therefore, the output order processing part 30 rearranges the processed images and the images for the promotion prints in a predetermined print output order, in which the promotion prints and the product prints corresponding to the promotion prints are outputted consecutively in one lot, and outputs the rearranged images to the output apparatus 12.

Aside from the condition described above, there is no specific limitation on the output order of the prints.

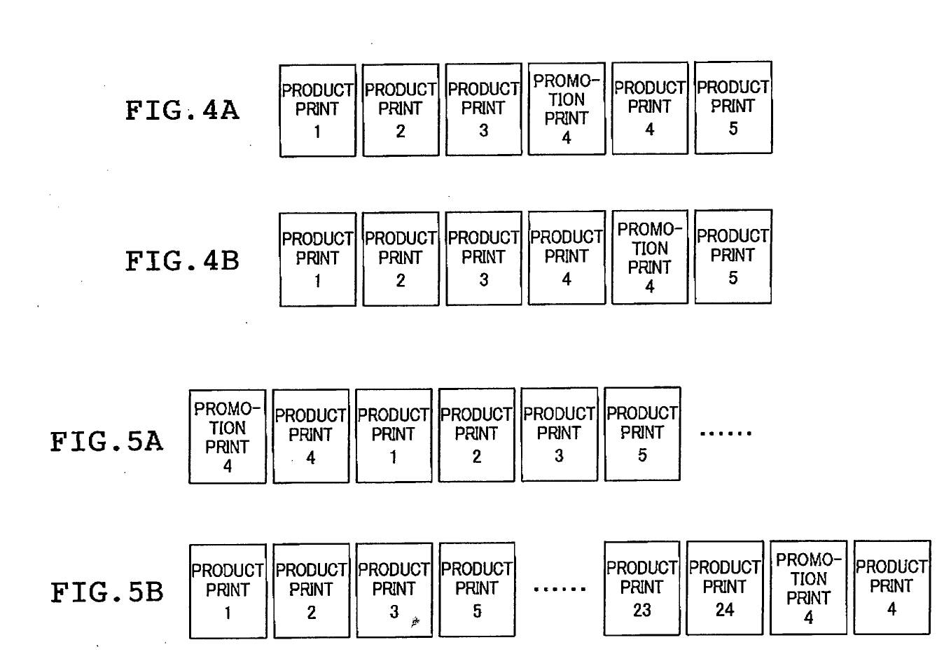

Here, it is ordinary that the product prints are fundamentally outputted in the order of frame numbers (file numbers and optionally folder numbers). Therefore, for instance, it is possible to use a method with which the product prints are outputted in the order of frame numbers and the promotion prints are outputted (inserted) immediately before or after their corresponding product prints. With the method, when a promotion print is created for the image in the fourth frame, for instance, as shown in FIG. 4A, the output order processing part 30 arranges images so that the first to third frames are outputted as product prints in order, thereafter, the promotion print of the fourth frame is outputted and then the product print of the fourth frame is outputted, and the fifth and later frames are outputted as product prints in order in accordance with frame numbers.

Alternatively, as shown in FIG. 4B, the output order processing part 30 may arrange the images so that the product print of the fourth frame is first outputted and then the promotion print of the fourth frame is outputted. The numerals in FIGS. 4A and 4B indicate the frame numbers.

Aside from the method, it is also possible to use a method with which the output order processing part 30 adjusts the output order so that the promotion prints and their corresponding product prints are collectively outputted at the start or the end of one lot.

With the method, when a promotion print is created for the image in the fourth frame, for instance, as shown in FIG. 5A, the output order processing part 30 arranges images so that the promotion print of the fourth frame is first outputted, the product print of the fourth frame is next outputted, and then the product prints of the first and later frames (except for the fourth frame) are outputted in order in accordance with the frame numbers.

Alternatively, as shown in FIG. 5B, the output order processing part 30 may arrange the images so that the product prints of the first and later frames (except for the fourth frame) are outputted in order in accordance with the frame numbers, the promotion print of the fourth frame is outputted next to the product print of the last frame (24th frame, in the illustrated example), and the product print of the fourth frame is outputted next to the promotion print of the fourth frame.

When the promotion print and its corresponding product print are collectively outputted at the start or the end of one lot in the manner described above, the output order of the promotion print and the product print is not specifically limited, and the output order in the examples shown in FIGS. 5A and 5B may be interchanged so that the product print is first outputted and the promotion print is next outputted.

Also, in the examples shown in FIGS. 5A and 5B, the product print corresponding to the promotion print (product print of the fourth frame, in the illustrated example) is not outputted among the product prints outputted in the order of the frame numbers, but the present invention is not limited to this and the product print corresponding to the promotion print may be outputted also among the product prints outputted in the order of the frame numbers. In this case, product prints which have the same image thereon and which correspond to the promotion print are outputted twice.

It should be noted that in the present invention, the output order of the promotion prints may be fixed. Alternatively, multiple output orders may be set in advance and a selection from among the output orders may be made.

After having received the processed images and the images for the promotion prints from the input apparatus 10, the output apparatus 12 operates in the manner described above. That is, the output apparatus 12 draws out the printing paper wound in a roll form and cuts the drawn-out printing paper in accordance with print sizes. Following this, the output apparatus 12 forms latent images by exposing the printing paper with recording light modulated in accordance with the images supplied from the input apparatus 10 while conveying the printing paper in a predetermined direction (auxiliary scanning direction), next performs development and drying, and then outputs the product prints, on which only the processed images have been reproduced, and the promotion prints while performing sorting in units of lots.

Here, when the size of the promotion prints or the size of the promotion prints and their corresponding product prints is changed from that of ordinary product prints, it is preferable that the long-side size of the printing paper wound in a roll form be changed as described above. In this case, the output apparatus 12 changes the drawing-out and cutting length of the rolled printing paper in accordance with the size of the promotion prints or the size of the promotion prints and their corresponding product prints.

Also, instead of or in addition to the output of the processed images and the images for the promotion prints arranged in the predetermined order to the output apparatus 12, the input apparatus 10 may record the images in storage media collectively in units of lots and/or output the images to external apparatuses through a communication network or the like collectively in units of lots.

It should be noted that in the illustrated example, the arrangement of the processed images and the images for the promotion prints in the predetermined order is performed at the output order processing part 30 of the input apparatus 10.

However, the present invention is not limited to this. For instance, the processed images and the images for the promotion prints may be supplied from the input apparatus 10 to the output apparatus 12 in order when output of the images becomes possible and the image arrangement described above may be performed at the output apparatus 12 before the print output.

As is apparent from the above description, with the image forming apparatus according to the present invention, in image formation in which high-grade processing, such as red eye correction, scratch removal, lens aberration correction, or deteriorated marginal luminosity correction, is performed, images are selected from among images in one lot relevant to each other, such as images photographed on one roll of film, images recorded in a recording medium, or images corresponding to one order, and product images having undergone the high-gradation processing and promotion images having undergone only the fundamental processing are outputted for the selected images, so it becomes possible to make a customer requested print creation or the like notice and recognize the high-grade processing executed at much expense in time and effort and the effect of the high-grade processing with reliability. In addition, the promotion images and the processed images are outputted consecutively, so it becomes possible to notify the customer of the existence and effect of the promotion images with reliability.

Thus, according to the present invention, it becomes possible to achieve high-value-added prints and the like, differentiation from images not having undergone the high-grade processing, differentiation from other stores such as laboratory stores, price maintenance with respect to other stores, acquiring and ensuring of customers, and the like.

In the embodiment shown in FIG. 1A, promotion target images are selected in accordance with instructions inputted by an operator or the like, but the present invention is not limited to this and the promotion target image selection may be automatically made by the apparatus through analysis of information concerning images, that is, images (image data) and photographing information (automatic selection of promotion target image).

Hereinafter, an embodiment in this case will be described with reference to FIG. 1B. At an image automatic selection part 36, the automatic selection of promotion target image is carried out. The image automatic selection part 36 includes a high-grade processing part 34 and an optimum image discrimination part 38. In this embodiment, the image automatic selection part 36 is included in an image processing part 24, but the present invention is not limited to this. Each part in FIG. 1B that is the same as a part of the digital photoprinter shown in FIG. 1A is given the same reference numeral and the description thereof will be omitted as appropriate.

In this embodiment, except that promotion target image selection at the time of inspection is not performed, acquisition of images in one lot, display/inspection of inspection images, and execution of the fundamental processing on respective images (frames) in order are performed in the same manner as in the embodiment described above.

Images subjected to the fundamental processing at the fundamental processing part 32 are next subjected to the red eye correction (high-grade processing) at the high quality processing part 34 to thereby obtain the processed images. Also, unprocessed images, obtained by performing only the fundamental processing without performing the red eye correction, are sent also to the storage part 26 in order, and are stored therein. Here, the image automatic selection part 36 may acquire photographing information concerning each image having undergone the fundamental processing and may discriminate whether the image is to be stored in the storage part based on the photographing information.

That is, at this time, images that are found from the photographing information that they have not been photographed using an electronic flash cannot become targets of the red eye correction (high-grade processing), so that they cannot become targets of promotion images. Therefore, they are not required to be sent to the storage part 26. Like in the embodiment described above, it is possible to process such images as processed images without performing the red eye correction when it is impossible to acquire the photographing information or when it is impossible to make a judgment as to whether an electronic flash has been used at the time of photographing with reference to the photographing information, every unprocessed image in one lot are stored in the storage part 26 and the red eye correction is carried out on every image in one lot. That is, in this embodiment, every unprocessed image in one lot, or each unprocessed image out of every unprocessed image in one lot, which is judged with reference to photographing information that it has been photographed using an electronic flash, is stored in the storage part 26.

The red eye correction is performed in the same manner as described above.

That is, first, images that are found from the photographing information that they have not been photographed using an electronic flash are set as non-red eye images, and the red eye correction is ended at this time. The images are then set as images having undergone the fundamental processing and the red eye correction without actually performing the red eye correction, and are processed as processed images. For other images, first, the red eye candidate detection is performed, and next the face detection is performed on the peripheries of red eye candidates. Red eye candidates on whose peripheries a face has been detected are determined as red eyes and are subjected to the red eye correction. So, the other images are processed as processed images having undergone the fundamental processing and the red eye correction. Also, images in which no red eye candidate has been detected, and images in which no face has been detected on the peripheries of red eye candidates are set as non-red eye images, and the red eye correction is ended at this time. The images are processed as processed images having undergone the fundamental processing and the red eye correction without actually making image correction.

Each image having undergone the red eye correction at the high quality processing part 34 is sent to the optimum image discrimination part 38. The optimum image discrimination part 38 makes discrimination (evaluation) as to whether the red-eye-corrected image is optimum as a promotion image and then supplies the image to the output order processing part 30 as a processed image.

The optimum image discrimination part 38 performs discrimination of images that are optimum as promotion images using a result of the red eye detection at the time of the red eye correction described above in the following manner. The optimum image discrimination part 38 identifies images, with which it is possible to notify a customer of the execution of the red eye correction effectively, by making judgment based on a discrimination criterion set in advance using at least one of various elements such as the sizes of red eyes (sizes of faces), whether red eyes exist in the vicinities of the centers of images (image main parts), red eye probability (in terms of colors and color saturation), whether a specific human subject with red eyes was photographed in multiple images in one lot (whether the human subject with the red eyes is an important person), and the reliability of the red eye detection (magnitudes of judgment values in the red eye candidate detection, the face detection, and the like). That is, the optimum image discrimination part 38 compares images having undergone the red eye correction with images not having undergone the red eye correction with each other, selects at least one image with which it is possible to generate an output image through which it is possible for a customer to clearly find that the red eye correction has been performed, and sets the images as promotion target images.

In the illustrated embodiment, when the red eye correction has been ended, the optimum image discrimination part 38 evaluates the suitability of each image as a promotion image in order using the result of the red eye detection in the red eye correction based on the predetermined discrimination criterion. Then, when the evaluation of every image in one lot has been ended, the optimum image discrimination part 38 selects one image (one frame) having the highest evaluation result as a promotion target image. Alternatively, the optimum image discrimination part 38 may select a predetermined number of images having high evaluation results as promotion target images.

More specifically, for instance, the optimum image discrimination part 38 sets a situation, in which at least one red eye with a size of 2 mm or more exists on a promotion print, as an indispensable condition for selection as a promotion target image, and evaluates the suitability of each image satisfying the indispensable condition as a promotion image with reference to the distance of a red eye having the largest size in the image from an image center (screen center). That is, the optimum image discrimination part 38 discriminates an image, in which at least one red eye with a size of 2 mm or more exists and a red eye having the largest size in the image exists closest to an image center, as an optimum image, and selects the image as a promotion target image.

Alternatively, instead of the optimum image selection in which the evaluation results of all images in one lot are collectively compared with each other, the optimum image discrimination part 38 may perform the evaluation image by image in order, store only an image having a higher evaluation result in the storage part 26, and select an image that remains to the last in the storage part 26 as an optimum promotion target image. More specifically, when the fundamental processing of the image in the first frame has been ended, an unprocessed image is stored in the storage part 26 and the red eye correction is performed on the image at the high-grade processing part 34 in the same manner as above. Evaluation based on the discrimination criterion for discrimination of an image that is optimum as a promotion image is made at the optimum image discrimination part 38 using a result of the red eye detection, and a result of the evaluation is sent to the storage part 26. When the fundamental processing of the image in the second frame has been ended, an unprocessed image is stored in the storage part 26, the red eye correction is performed on the image at the high-grade processing part 34, the evaluation is made, and a result of the evaluation is sent to the storage part 26 in the same manner. In the storage part 26, the evaluation results of the images in the first and second frames are compared with each other, one of the images having a higher evaluation result is left as a promotion target image, and the other of the images is erased. Then, for the image in the third frame, the unprocessed image storage into the storage part, the red eye correction, the evaluation, and the sending of the evaluation to the storage part 26 are performed in the same manner. At the storage part 26, the evaluation result of the stored promotion target image and the evaluation result of the image in the third frame are compared with each other, and one of the images having a higher evaluation result is left as a promotion target image. Following this, the same processing is performed for the fourth frame, the fifth frame and so on, and an image, which remains in the storage part 26 at the time when the processing has been performed for every image in one lot, is selected as a promotion target image. Note that when multiple promotion target images are to be selected, it is sufficient that a predetermined number of images be first stored in the storage part 26, the evaluation result of an image having the lowest evaluation result and the evaluation result of a supplied image are compared with each other, and one of the images having a lower evaluation result is erased from the storage part 26, for instance.

The unprocessed image that remains to the last in the storage part 26 is sent to the promotion processing part 28 as an unprocessed image of a promotion target image to be reproduced on a promotion print. Here, when the promotion print is created by reproducing a promotion image and a processed image, a processed image of the image selected as the promotion target image is also sent to the promotion processing part 28. Therefore, in this case, the processed image corresponding to the unprocessed image that remains in the storage part 26 needs to be stored at the input apparatus 10 even after the optimum image discrimination has been ended.

Also, processed images having undergone the red eye correction and the optimum image discrimination are supplied to the output order processing part 30 at a predetermined timing as (product) images to be reproduced on product prints.

It should be noted that even with the method, like in the embodiment described above, it is not required to send unprocessed images of images, which are found at a time of execution of the red eye correction from a result of analysis of photographing information that they have been photographed not using an electronic flash, to the storage part 26, and it is possible to set the images as processed images having undergone the red eye correction without performing the red eye correction.

It should be noted that this embodiment, in which the automatic selection of promotion target image is performed, is not limited to the construction in which promotion images are selected through the optimum image discrimination. For instance, in this embodiment, a predetermined number of images (frames), in which red eyes have been detected first, may be automatically selected as promotion images. Alternatively, in the same manner, the promotion image evaluation may be made so that each time the red eye correction has been made on one image, the evaluation is made for selecting promotion target images, and images having evaluation results exceeding a threshold value set as appropriate may be automatically selected as promotion target images. Then, the promotion image selection processing may be ended when a predetermined number of images have been selected.

Also, several discrimination criteria may be prepared for the promotion target image selection and a selection from among the discrimination criteria may be made, and/or a discrimination criterion may be set arbitrarily.

After promotion target images have been selected in the manner described above, the image automatic selection part-36 sends a result of the selection to the storage part 26.

The storage part 26 receives the selection result, selects corresponding images from among unprocessed images stored therein, gives the selected images information showing that they are promotion target images, and sends the images with the information to the promotion processing part 30 that creates images for promotion prints. In addition, the storage part 26 erases other unprocessed images as necessary.

Processing after selecting the promotion target images and sending the promotion target images to the promotion processing part 28 is the same as that in the embodiment of the manual selection described above. That is, the input apparatus 10 creates images for promotion prints at the promotion processing part 28, arranges processed images and the images for the promotion prints in a predetermined order at the output order processing part 30, and sends the arranged images to the output apparatus 12. The output apparatus 12 creates product prints, on which the processed images have been reproduced, and the promotion prints, and sorts the prints in units of lots.

Alternatively, like in the embodiment described above, the input apparatus 10 arranges the processed images and the images for the promotion prints in the predetermined order at the output order processing part 30, records the arranged images on storage media collectively in units of lots, and outputs the images to the outside through a communication network or the like collectively in units of lots, for instance.

In this embodiment in which promotion target images are automatically selected in the manner described above, regardless of which one of the form in which the promotion target images are selected after the red eye correction has been performed on every image, and the form in which the promotion target images are selected by performing comparison each time one image has been subjected to red eye correction, is adopted, when there exists no image satisfying the indispensable condition (minimum criterion) in discrimination of images that are optimum as promotion images (for instance, in the embodiment described above, when there exists no image having a red eye that is 2 mm or more on a promotion print), it is impossible to sufficiently provide the effect of promotion prints, so it is preferable that the promotion prints be not created.

Up to this point, the embodiment, in which the promotion target image selection processing is performed through one of the manual selection (selection in accordance with instructions inputted by an operator) and the automatic selection (selection through analysis of images and photographing information), has bee described.

However, the present invention is not limited to this, and a construction, in which it is possible to make a selection from among the manual selection and the automatic selection, may be used instead. More specifically, for instance, in a digital photoprinter or the like that carries out the present invention, a mode (manual mode) in which promotion target images are selected through the manual selection, and a mode (automatic mode) in which promotion target images are selected through the automatic selection, may be set as operation modes, and a selection from among the modes may be made.

Through the automatic selection, it is possible to save operator's labor and improve productivity. In addition, even when the apparatus is operated by an unskilled operator, it is possible to select appropriate promotion target images and create suitable promotion prints with stability.

On the other hand, through the manual selection, it is possible to select images, with which it is possible to make a customer feel the effect of the red eye correction at a maximum but which will not be selected through the automatic selection, as promotion target images. For instance, an image in which the eyes of a baby or an infant are colored in red gives a customer an extremely unpleasant feeling, so when the image is selected as a promotion target image, it becomes possible to make the customer feel the effect of the red eye correction very strongly. However, when a large number of images exist in the same lot whose evaluation results are higher than that of the image in which the eyes of a baby or an infant are colored in red, with respect to the discrimination criteria, the image will not be selected as a promotion target image through the automatic selection. However, by performing the manual selection, it becomes possible to select such an image, which will not be selected through the automatic selection but is effective in notifying a customer of the effect of the red eye correction, as a promotion target image, which makes it possible to create a more effective promotion print.

Accordingly, by making it possible to perform switching between the manual selection and the automatic selection of promotion target images using a method with which, for instance, the automatic mode and the manual mode are provided in the manner described above, it becomes possible to cope with both improvements in operability and productivity or ensuring of versatility of processing/operation and higher-grade processing, which makes it possible to further improve the effect of the promotion print creation described above.

In addition, with a method with which selection means is provided, through setting of work modes, or the like, it may be made possible to select the high-grade processing to be executed as appropriate.

In the embodiments described above, only promotion images are reproduced on promotion prints but the present invention is not limited to this. For instance, a template, which is a promotion print form (format) and has areas in which a promotion image and a processed image of its corresponding image (frame) are to be recorded, may be prepared and promotion prints (images) on which promotion images and processed images have been reproduced may be formed.

Alternatively, by setting modes or the like, it may be made possible to make a selection from among formation of promotion prints on which only promotion images have been reproduced, and formation of promotion prints on which promotion images and processed images have been reproduced.

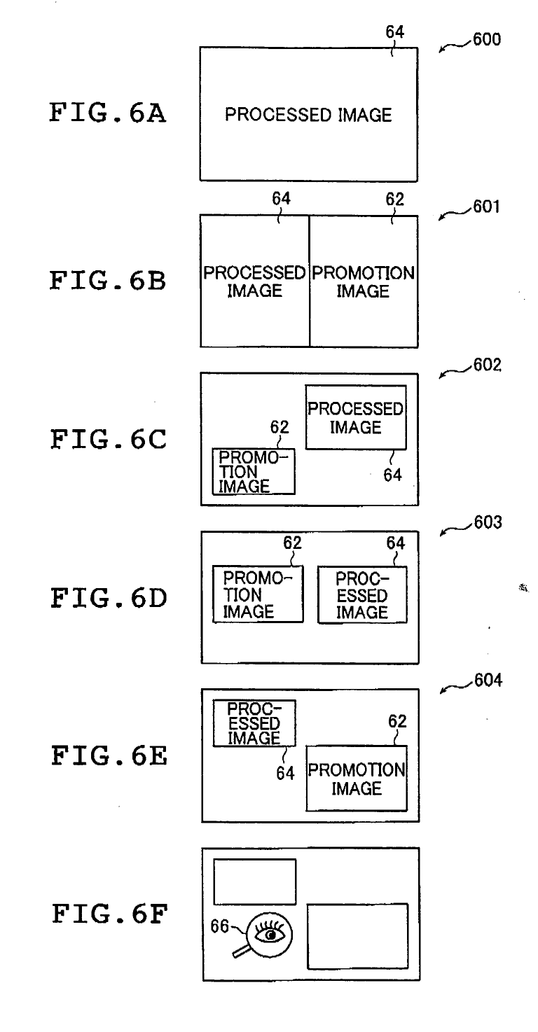

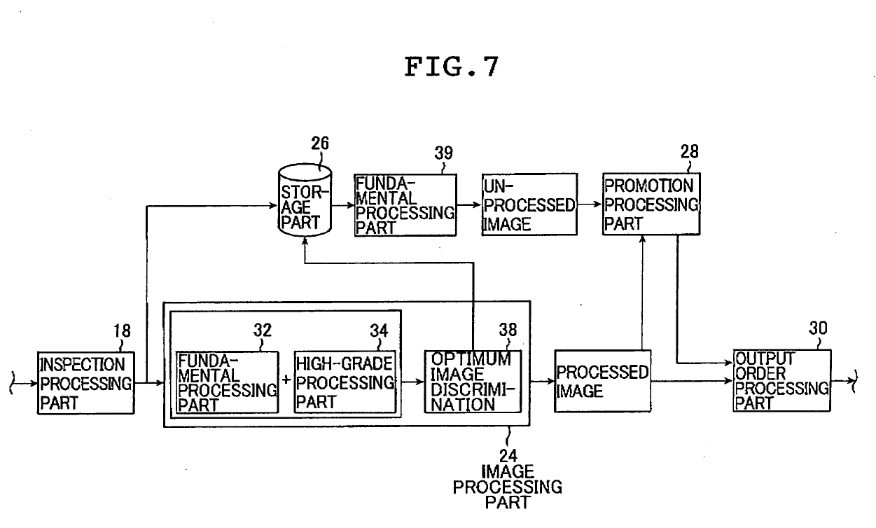

It is possible to make such a template selection at the template selection part 22 shown in FIG. 1A with a broken line. Hereinafter, examples of processing by the template selection part 22 will be described with reference to FIGS. 6A to 6F.

After promotion target images have been selected, the template selection part 22 displays a selection screen for selecting a template to be used as a promotion print form on the display 20 to prompt an operator to make a template selection. The template selection processing at the template selection part 22 may be performed immediately after the promotion target images have been determined or may be performed after inspection corresponding to one lot has been ended.

At the template selection part 22, for instance, a template 600 (hereinafter referred to as the “template of type A”) shown in FIG. 6A with which only a promotion image 62 is to be reproduced on one print, a template 601 (hereinafter referred to as the “template of type B”) shown in FIG. 6B with which the promotion image 62 and a processed image 64 are to be reproduced on one print without any margin, a template 602 (hereinafter referred to as the “template of type-C”) shown in FIG. 6C with which the processed image 64 and the promotion image 62 that is smaller than the processed image 64 are to be reproduced on one print, a template 603 (hereinafter referred to as the “template of type D”) shown in FIG. 6D with which the processed image 64 and the promotion image 62 having the same size are to be reproduced on one print, and a template 604 (hereinafter referred to as the “template of type E”) shown in FIG. 6E with which the processed image 64 and the promotion image 62 that is larger than the processed image 64 are to be reproduced on one print, are prepared so that a selection from among the templates is possible.

Also, in the templates, an image 66 shown in FIG. 6F, in which only uncorrected and/or corrected red eye parts have teen clipped and enlarged, and/or the like may be recorded. Note that the enlarged image 66 may be recorded in a blank part. Alternatively, the image 66 may be recorded so that a part thereof is recorded over an image. Still alternatively, the image 66 may be recorded so that the whole of the image 66 is recorded over an image. Also, the enlarged image 66 may be recorded on a promotion print on which only a promotion image has been reproduced.

When promotion prints are to be created by using such a template, the template selection screen is displayed on the display 20, thereby prompting an operator to make a template selection. The template selection part 22 acquires a template type (selection result) based on instructions inputted by the operator.

It should be noted that when promotion images are selected manually, the template selection at the template selection part 22 may be performed immediately after the promotion images have been determined or may be performed after inspection of every image in one lot has been ended. Also, the operator may make the template selection through a GUI or the like in which figures and/or characters indicating the template types are displayed, for instance.

In FIG. 1A, a result of the template selection at the template selection part 22, that is, information showing a selected promotion print template is sent to the promotion processing part 28. Also, like in the embodiments described above, unprocessed images of images selected as promotion target images at the promotion image selection part 16 are stored in the storage part 26. The unprocessed images are read from the storage part 26 at a predetermined timing and are supplied to the promotion processing part 28, which creates images for promotion prints, as unprocessed images that will become promotion images. In addition, the information showing the selected promotion print template is also supplied to the promotion processing part 28.

Also, when processed images have been obtained by performing the red eye correction in the manner described above, or further the optimum image discrimination has been performed, aside from supply of processed images for product prints (that is, product images) to the output order processing part 30, processed images corresponding to the selected promotion target images are supplied to the promotion processing part 28. Accordingly, in the case of the automatic promotion target image selection, until the promotion target images have been determined, it is required to store processed images formed.

In the promotion processing, in accordance with the selected template, images for promotion prints in which promotion images have been reproduced, are formed, and are outputted to the output order processing part 30 at a predetermined timing. Here, the promotion processing may be changed to some extent in accordance with the selected template.

For instance, when the template of type A has been selected as the promotion print template, in accordance with the progress of the red eye correction of each image in one lot, unprocessed images of promotion target images are read from the storage part at an appropriate timing and are supplied to the promotion processing as unprocessed images that will become promotion images.

Here, when promotion prints are created using the template of type A, the promotion prints may be prints obtained by forming images for the promotion prints so that unprocessed images of promotion target images are reproduced as promotion images as they are, and reproducing the promotion images (unprocessed images) in completely the same manner as processed images for product prints.

However, it is preferable that the images for the promotion prints be created in the manner described below. That is, margin parts are provided on the prints by forming the promotion images while reducing the unprocessed images ox the margin parts are provided on the prints by using the unprocessed images as the promotion images as they are and setting the print size of the promotion prints larger than that of the product prints, and a comment for making a customer recognize that, for instance, the red eye correction has been carried out is recorded in the margin parts outside the promotion images.

The contents of the comment are not specifically limited and it is possible to cite the examples described above.

Also, as to a method of setting the contents of the comment, like in the example described above, it is preferable that multiple comments be set in advance and a selection from among the comments is made, and it is also preferable that an arbitrary setting be possible. Further, it is preferable that the recording position, font, character size, color, and the like of the comment be selectable/settable arbitrarily.

On the other hand, when one of the template of type B, the template of type C, the template of type D, and the template of type E has been selected as the promotion print template, the processed images of the images selected as the promotion target images not only are outputted to the output order processing part 30 but also are supplied to the promotion processing part 28 when the red eye correction has been ended.

In addition, the unprocessed images of the promotion target images stored in the storage part 26 are read from the storage part 26 at a predetermined timing (when the red eye correction of corresponding images has been ended, for instance) and are supplied to the promotion processing as unprocessed images that will become promotion images.

When one of the template of type B to the template of type E has been selected as the template, when the processed images and the unprocessed images of the promotion target images have been supplied to the promotion processing, the promotion processing is executed and the images for the promotion prints are created.

When the unprocessed images and the processed images of the promotion target images have been sent to the promotion processing, the promotion processing is started.

At this time, first, the sizes of the promotion image and the processed image to be recorded on the promotion print are determined in accordance with the selected template, and the promotion image and the processed image to be fitted into the template are formed by resizing (adjusting the sizes of) the unprocessed image and the processed image of the promotion target image in accordance with the determined sizes. Note that a method of resizing the images is not specifically limited and it is sufficient that a known method, such as thinning-out or electronic scaling processing, is used. Alternatively, instead of reduction, image clipping may be performed in accordance with the size of each image in the template so that a region subjected to the red eye correction exists at a center.

Next, the image for the promotion print is formed by fitting the promotion image and the processed image obtained through the resizing at predetermined positions of the selected template. Here, even when the promotion prints are created by using one of the template of type B to the template of type E, it is preferable that the images for the promotion prints be created so that the comment same as above is recorded in blank parts other than image regions.

Also, on the promotion prints, in addition to the promotion images, and optionally the processed images and the comment, the image shown in FIG. 6F, in which only uncorrected and/or corrected red eye parts have been clipped and enlarged, and/or the like may be recorded. Note that the enlarged image may be recorded in blank parts. Alternatively, the enlarged image may be recorded so that a part thereof is recorded over images. Still alternatively, the enlarged image may be recorded so that the whole enlarged image is recorded over images.

Further, it is preferable that the print size of the promotion prints be set larger than (or conversely smaller than) that of the product prints because it becomes possible to make a customer recognize existence of the promotion prints with reliability.

After the images for the promotion prints have been formed by fitting the promotion images and the processed images into the selected template in the manner described above, the images for the promotion prints are sent to the output order processing part 30. Following this, output of the product prints and the promotion prints, recording of the images to a recording medium, and the like are performed in the same manner as above.

In the present invention, when the promotion prints are created by using the template, the images for the promotion prints outputted from the promotion processing part 28 and the processed images may be outputted to the output apparatus 12 without providing the output order processing part 30.

In this case, the output positions of the promotion prints in print output (image output) in one lot are not specifically limited. For instance, it is possible to use a method with which the promotion prints are outputted at the start or the end of one lot. In order to make the effect of the promotion prints more suitable by notifying a customer of the execution of the red eye correction (high-grade processing) and recognize the effect of the red eye correction with more reliability, it is preferable that the promotion prints be outputted immediately before or immediately after the product prints of the promotion target images as described above.

Such setting of the output positions of the product prints and the promotion prints may be achieved by holding the images at the input apparatus 10 and supplying each image for a print to the output apparatus 12 in a predetermined order, or by rearranging the images in the output apparatus 12 and outputting the prints in a predetermined order.

It is sufficient that the reduction of the images and the fitting of the images into the template (image synthesis) are performed with known electronic scaling processing and image synthesis.

Also, even when the promotion prints (images thereof) on which the promotion images and their corresponding processed images have been reproduced are formed using the template in the manner described above, it is preferable that the images for the promotion prints be formed so that a comment is recorded in margin parts (provided intentionally in the case of FIG. 6B) of the promotion prints in the same manner as above, and it is also preferable that the size of the promotion prints and the size of the product prints be set to be different from each other like in the examples described above.

Further, the number of the types of the templates is not limited to five and may be six or more, four or less, or may be one. In addition, the arrangement, size and the like of each image are also settable arbitrarily.

Still further, a template dedicated to high-grade processing to be executed, such as a template for the red eye correction, may be possessed.

It should be noted that in the examples described above, as a preferable form, after the red eye correction (high-grade processing) has been performed, the images (processed images and promotion images) are changed (resized) into images having sizes corresponding to the template. However, the present invention is not limited to this, and in this form in which the promotion images are selected in advance, the images may be first resized for the promotion prints and then the fundamental processing and the red eye correction may be performed for the promotion prints.

Also, depending on the high-grade processing to be executed or a combination in the case where multiple high-grade processing is performed, there is also a case where it is preferable that prior to the fundamental processing, the high-grade processing (or some thereof) be executed.

A part of a construction of an image forming apparatus that realizes such processing is schematically shown in FIG. 7. In an embodiment shown in FIG. 7, original images sent from the inspection processing part 18 are subjected to the fundamental processing and the high-grade processing for obtaining processed images at the image processing part 24. Like in the embodiments described above, the image processing part 24 includes the fundamental processing part 32 and the high-grade processing part 34 so that the high-grade processing is carried out prior to the fundamental processing. Each original image from the inspection processing part 18 is not only sent to the image processing part 24 but also sent to a storage part 26 and is stored therein. Each image having undergone the image processing at the image processing part 24 is sent to the optimum image discrimination part 38, at which it is judged whether the image is optimum as a promotion target image. The function of the optimum image discrimination part 38 is the same as that described above. A result of the discrimination at the optimum image discrimination part 38 is sent to the storage part 26. Based on the discrimination result, the storage part 26 outputs each original image corresponding to an image selected as a promotion target image to a fundamental processing part (second fundamental processing part) 39 that is different from the image processing part 24. The second fundamental processing part 39 generates an unprocessed image by performing the fundamental processing on each original image extracted from the storage part 26 and outputs the unprocessed image to the promotion processing part 28. Among processed images having undergone the promotion target image discrimination processing at the optimum image discrimination part 38, a processed image selected as a promotion target image is sent to the promotion processing part 28, at which the selected processed image is subjected to promotion processing. Every processed image including the processed image selected as a promotion target image is outputted to the output order processing part 30. The promotion processing part 30 creates images for promotion prints in accordance with processing that is the same as that in the embodiments described above and outputs the images to the output order processing part 30. At the output order processing part 30, output order is adjusted. Then, at the output apparatus 12, the promotion prints and the product prints are outputted.

As is apparent from the above description, according to the present invention, in image formation in which the high-grade processing, such as the red eye correction, the dust/scratch removal, the lens aberration correction and the deteriorated marginal luminosity correction, is performed, images are selected from among images in one lot relevant to each other, such as images corresponding to one order photographed on one roll of film or recorded in a recording medium, and processed images having undergone the high-grade processing and promotion images that are images completed by performing the fundamental processing without performing the high-grade processing are outputted, so it becomes possible to make a customer requesting print creation or the like notice and recognize the execution of the high-grade processing at much expense in time and effort and the effect of the high-grade processing with reliability. Also, by storing images having undergone only the fundamental processing or original images to be described later in predetermined storage part, and forming the images for the promotion prints by reading the images therefrom, it becomes possible to eliminate the necessity for image re-reading and the like, which makes it possible to create the promotion prints with efficiency through simple processing.

Thus, according to the present invention, it becomes possible to achieve high-value-added prints and the like, differentiation from images not having undergone the high-grade processing, differentiation from other stores such as laboratory stores, price maintenance with respect to other stores, acquiring and ensuring of customers, and the like.

In the embodiments described above, the red eye correction is performed as the high-grade processing (second image processing), but as described above, in the present invention, it is possible to perform various other image processing which corrects image defects, as the high-grade processing. It is preferable that image processing that corrects only images, in which defects have been detected as a result of analysis of information concerning the images, be performed, and it is more preferable that the scratch removal processing, the lens aberration correction, the deteriorated marginal luminosity correction, or the like described above be performed.

It is sufficient that like the red eye correction, each high-grade processing described above is performed with a known method.

For instance, it is sufficient that the scratch removal processing is performed with a method disclosed in JP 2000-74846 A with which each line segment satisfying a condition is detected through edge detection, each defective part ascribable to a dust or a scratch is detected using the line segment, and the defective part is corrected through complementation using continuity with peripheral pixels or image data of peripheral regions or the like, a method disclosed in JP 2000-92319 A with which each defect candidate region ascribable to a dust or a scratch is detected with reference to the magnitude of a difference between a smoothed image and an original image, each defective part is detected with reference to characteristics of the candidate region such as changes in shape and color, and the defective part is corrected in the same manner as above, or the like.

In addition, when image formation from images photographed on a photographic film is performed, it is also possible to suitably use a method with which image reading with IR light (infrared light) is performed in addition to ordinary image reading in R (red), G (green), and B (blue), the position of each dust or scratch on the film is detected using a result of the reading with the IR light which is shielded or scattered by the dust or scratch on the film, and each defective part is corrected in the same manner as above.

When the scratch removal is performed as the high-grade processing, in the case where promotion target images are automatically selected like in the embodiment shown in FIG. 1B, it is sufficient that at least one image, with which it is possible to notify a customer of the execution and effect of the scratch removal processing with efficiency, is selected by comprehensively judging at least one of the lengths of dusts and scratches, the thicknesses of the dusts and scratches, the number of the dusts and scratches, whether the dusts and scratches overlap main subjects such as faces, whether the positions of the dusts and scratches are close to the center parts of images (image main parts), and the like using a result of detection of the dusts and scratches.

Further, as a scratch removal method, when the dust and scratch position detection using the IR light is performed, images not having IR-light images may be set as images that cannot become targets of the high-grade processing. In this case, the images are not stored in the storage part and may be dealt with as images having undergone the high-grade processing.

On the other hand, as a method of performing the lens aberration correction and the deteriorated marginal luminosity correction, there is disclosed a method in JP 11-225270 A with which the lens characteristics of cameras are acquired and stored in advance, the type (lens type) of a camera used to photograph images is detected, and the lens aberration correction and/or the deteriorated marginal luminosity correction are/is performed using the lens characteristics corresponding to the detected camera type, for instance. Note that in the case of image formation from an APS film, it is sufficient that the lens type is detected by also reading magnetic information at the time of reading with a scanner and analyzing the information. On the other hand, in the case of image formation from images photographed with a digital camera or the like, it is sufficient that the lens type is detected by analyzing various kinds of information recorded in image files.

In the case where the lens aberration correction and the deteriorated marginal luminosity correction are performed as the high-grade processing, when promotion target images are automatically selected like in the embodiment shown in FIG. 1B, it is sufficient that at least one image, with which it is possible to notify a customer of the execution and effect of the lens aberration correction and the deteriorated marginal luminosity correction with efficiency, is selected by comprehensively judging the magnitudes of aberration and deteriorated luminosity, conspicuous degrees of the aberration and deteriorated luminosity, and the like. It is sufficient that the magnitudes and the conspicuous degrees of the aberration and deteriorated luminosity are discriminated by detecting changes of the aberration and deteriorated luminosity on concentric circles whose center exists at the center of a screen and whose sizes are gradually increased, for instance.

In addition, when the lens aberration correction and the deteriorated marginal luminosity correction are performed as the high-grade processing, images, for which the lens type discrimination and the lens characteristic acquisition have been made in failure, may be set as images that cannot become targets of the high-grade processing. In this case, the images may be dealt with as images having undergone the high-grade processing without storing them in the storage part.

It should be noted that as a matter of course, the number of kinds of the high-grade processing including the red eye correction, the dust/scratch removal processing, the lens aberration correction, and the deteriorated marginal luminosity correction carried out on images in the present invention is not limited to one and may be two or more.

It should also be noted that the present invention is not limited to creation of photographic prints using printing paper, such as the photographic print creation shown in the illustrated embodiments, and may be applied to image formation (print (hard copy) creation) using a thermal recording medium, a printer using a photosensitive thermal recording medium, a printer using a photosensitive medium, an ink jet printer, an electrophotographic printer, or the like.

Here, the recording medium and image recording method (drawing method) for the product prints and those for the promotion prints may be different from each other. However, it is preferable that the promotion prints be created using a recording medium and an image recording method that are the same as those for the product prints in terms of the effectiveness of notifying a customer of the effect of the high-grade processing through comparison between the product prints and the promotion prints, the material feeling of the promotion prints, and the like. In particular, in creation of photographic prints, output of promotion prints as photographic prints which have been obtained by recording promotion images on printing paper is preferable in terms of the material feeling of the promotion prints, customer satisfaction, the effectiveness of notifying a customer of the execution and effect of the high-grade processing, and the like.

Also, if it is possible in accordance with an image forming method, instead of forming images only on one side of the surfaces of prints (hard copies), prints with product images reproduced on front surfaces and promotion images reproduced on back surfaces may be outputted as promotion prints or product prints, for instance.

Further, in the present invention, it is more preferable that images for promotion prints or the images for the promotion prints and images for product prints be displayed on a display or the like at the time of output of the promotion prints, thereby making it possible to confirm the appeal effect of the promotion prints and the effect of the high-grade processing.

Still further, it is also preferable that the same service can be provided through an unmanned photographing apparatus installed at a store or the like, a print creation apparatus installed at a store, a photographic print order reception apparatus installed at a store, and the like.

The image forming method and the image forming apparatus according to the present invention have been described in detail above, but the present invention is not limited to the embodiments described above, and it is of course possible to make various modifications or changes without departing from the gist of the present invention.

What is claimed is:

1. An image forming method, comprising the steps of:
generating product images by performing a first image processing and a second image processing on all of images in one lot that are optically photographed;
selecting at least one target image from among said images in the one lot; and
outputting said product images and an unprocessed image obtained by performing only said first image processing on said target image.

2. The image forming method according to claim 1,
wherein the step of outputting includes outputting said unprocessed image and one of said product images corresponding to said unprocessed image consecutively in the one lot.

3. The image forming method according to claim 1,
wherein said first image processing is image processing for image completion and said second image processing is image processing for image defect correction.

4. The image forming method according to claim 3,
wherein said second image processing is performed on said images after said first image processing.

5. The image forming method according to claim 2, further comprising the steps of:
storing the unprocessed image in storage means; and
reading the unprocessed image from said storage means in accordance with progress of said second image processing in the one lot to output said unprocessed image.

6. The image forming method according to claim 1, further comprising the steps of:
storing said target image in predetermined storage means;
reading said target image from said storage means in accordance with progress of said first image processing and said second image processing in the one lot; and
outputting said target image that is read after being subjected to said first image processing.

7. The image forming method according to claim 3,
wherein said second image processing includes the steps of:
analyzing information concerning each of said images to detect existence or nonexistence of an image defect; and
performing an image defect correction only on an image detected to have an image defect in the step of analyzing information.

8. The image forming method according to claim 7,
wherein said information concerning each of said images contains at least one of an image and a photographing information.

9. The image forming method according to claim 3,
wherein said first image processing comprises an image enlargement/reduction, a gradation correction, a color/density correction, a color saturation correction, a sharpness processing and a dodging processing, and the second image processing comprises at least one of a red eye correction, an image defective part correction, a correction of aberration ascribable to a photographing lens and a correction of deteriorated marginal luminosity ascribable to the photographing lens.

10. The image forming method according to claim 1,
wherein the step of selecting includes selecting said at least one target image in accordance with an inputted instruction, a result of analysis of an information concerning each of the images, or a selected one of the inputted instruction and the result of analysis of the information concerning each of the images.

11. The image forming method according to claim 1,
wherein the step of outputting said product images and said unprocessed image includes the steps of;
outputting said product images in order corresponding to numbers of said images in the one lot and
outputting said unprocessed image immediately before or immediately after one of said product images that corresponds to said unprocessed image.

12. The image forming method according to claim 1,
wherein the step of outputting said product images and said unprocessed image includes outputting said unprocessed image and one of said product images that corresponds to said unprocessed image at a start or an end of the one lot.

13. The image forming method according to claim 1,
wherein the step of outputting said product images and said unprocessed image includes outputting product prints with the product images reproduced thereon and a reference print with the unprocessed image reproduced thereon by using the same kind of recording medium and the same image recording method.

14. The image forming method according to claim 13,
wherein the recording medium includes printing paper.

15. The image forming method according to claim 13,
wherein the reference print differs from the product prints in print size.

16. The image forming method according to claim 1,
wherein the step of outputting said product images and said unprocessed image includes reproducing an image obtained by performing the first image processing and the second image processing, and the unprocessed image obtained by performing only the first image processing on a hard copy.

17. The image forming method according to claim 1,
wherein the step of outputting said product images and said unprocessed image includes outputting a first image data containing the product images and a second image data that contains the unprocessed image and differs from the first image data in at least one of a data size and a header information.

18. An image forming apparatus, comprising:
image acquisinon means for acquiring all of images in one lot that are optically photographed;
processing means for performing a first image processing that is image processing for image completion and a second image processing that is image processing for image defect correction on the images acquired; and
selection means for selecting at least one target image from among said images in the one lot,
wherein said processing means generates a product image by performing both of said first image processing and said second image processing and an unprocessed image by performing only said first image processing for the target image, and outputs both of the product image and the unprocessed image.

19. The image forming apparatus according to claim 18, further comprising:
arrangement means for outputting the images in predetermined order,
wherein said arrangement means sets image output order so that the unprocessed image and the product image corresponding to the unprocessed image are outputted consecutively in the one lot.

20. The image forming apparatus according to claim 1B, further comprising;
storage means for storing said images and said unprocessed image,
wherein said unprocessed image is read from said storage means and is outputted in accordance with progress of said second image processing in the one lot.

21. The image forming apparatus according to claim 18, further comprising:
storage means for storing the images and said target image,
wherein said target image is read from said storage means in accordance with progress of said first image processing and said second image processing in the one lot, and is outputted after being subjected to said first image processing.

22. The image forming apparatus according to claim 18,
wherein said first image processing comprises an image enlargement/reduction, a gradation correction, a color/density correction, a color saturation correction, a sharpness processing and a dodging processing, and said second image processing comprises at least at least one of a red eye correction, an image defective part correction, a correction of aberration ascribable to a photographing lens and a correction of deteriorated marginal luminosity ascribable to the photographing lens.

23. The image forming apparatus according to claim 18,
wherein said selection means comprises at least one of first selection means for selecting the target image in accordance with instruction inputted from outside and second selection means for selecting the target image through analysis of an information concerning each of the images,
wherein one of a selection by said first selection means and a selection by said second selection means is selected as a mode in a case where the selection means includes both of the first selection means and the second selection means.
